(19) United States
(12) Patent Application Publication
(10) Pub. No.: US 2019/0272605 A1
(43) Pub. Date: Sep. 5, 2019

(54) Trust Systems and Methods for Facilitating Funding of Real Estate Improvements

(71) Applicant: Errol Anderson, Denver, CO (US)

(72) Inventor: Errol Anderson, Denver, CO (US)

(21) Appl. No.: 16/293,614

(22) Filed: Mar. 5, 2019

Related U.S. Application Data
(60) Provisional application No. 62/638,792, filed on Mar. 5, 2018.

(51) Int. Cl. G06Q 50/16; G06Q 40/02

(52) U.S. Cl. CPC G06Q 50/165; G06Q 50/167; G06Q 40/025

(57) ABSTRACT

Disclosed is a system and method to facilitate the transaction of real estate owned by a seller, organized by a real estate agent, and purchased by a buyer who finances the transaction using a mortgage loan from a mortgage lender. The system and method include incentives. For example, the real estate agent can offer a reduction of the real estate agent's commission. Also, the mortgage lender could provide an incentive in the form of an adjustment of the interest rate or points on the mortgage. The incentivized funds are placed in trust during closing, where the beneficiary of the trust consists solely of the real estate and improvements thereon. After closing, the trustee approves and disburses from the trust for the benefit of improvements on the real estate. The disbursements are limited to a network of pre-approved suppliers, vendors, contractors and tradesman.

### CROSS REFERENCE TO RELATED APPLICATIONS

This application is related to and claims priority to U.S. application 62/638,792 titled Trust Systems and Methods for Facilitating Real Estate Transfer filed on Mar. 5, 2018, the contents of which are incorporated by reference.

### BACKGROUND

Applicant is not aware of any system or method that facilitates the transfer of real estate with after-closing improvements as described herein.

### OBJECTS AND FEATURES

A primary object and feature of some embodiments is to provide real estate agents and mortgage lenders with the ability to offer financial incentives to induce real estate sales.

It is a further primary object and feature of some embodiments to provide funding for a reliable suppliers' network in order to make home improvements that are ancillary to the sale of a home.

It is a further primary object and feature of some embodiments to provide real estate documentation consistent with regulation of mortgage-backed real estate transactions.

It is a further primary object and feature of some embodiments to provide significant flexibility and funding for improving the real-estate after closing.

It is a further primary object and feature of some embodiments to utilize any excess credit generated as a result of a real estate purchase.

A further primary object and feature of some embodiments is to provide such a system that is safe, efficient, trustworthy, inexpensive and handy. Other objects and features of this invention will become apparent with reference to the following descriptions.

### SUMMARY

Disclosed is a system and method to facilitate the transaction of real estate owned by a seller, organized by a real estate agent, and purchased by a buyer who finances the transaction using a mortgage loan from a mortgage lender. The system and method include incentives. For example, the real estate agent can offer a reduction of the real estate agent's commission. Also, the mortgage lender could provide an incentive in the form of an adjustment of the interest rate or points on the mortgage. The incentivized funds are placed in trust during closing, where the beneficiary of the trust consists solely of the real estate and improvements thereon. After closing, the trustee approves and disburses from the trust for the benefit of improvements on the real estate. The disbursements are limited to a network of pre-approved suppliers, vendors, contractors and tradesman. In some embodiments the company that facilitates the trust process for improvement of the real estate does not pay a roll in the closing process. The home improvement program takes effect after the closing and may be separate from a closing service. The funds that will be placed in the 3rd part escrow company to be used to benefit the property can be identified on the closing statement as a normal line item and part of the deal.

### BRIEF DESCRIPTION OF THE DRAWINGS

FIG. 1 shows a use-case view that illustrates facilitating the transaction of real estate between a buyer and seller, that is organized by a real-estate agent, funded by a mortgage lender, and post-closing improvements guaranteed by a trustee and suppliers.

FIG. 2 shows a use-case view that illustrates oversight of the network of suppliers.

FIG. 3 shows a diagrammatic view that illustrates the settlement statement of funds at closing of the real estate transaction.

FIG. 4 shows a diagrammatic view that illustrates another settlement statement of funds at closing of the real estate transaction.

FIG. 5 shows a flowchart view that illustrates the process for disbursement to suppliers from the trust for improvements to the real estate.

### DETAILED DESCRIPTION

The present Trust Systems and Methods for Facilitating Real Estate Transfer will now be discussed in detail with regard to the attached drawing figures, which were briefly described above. In the following description, numerous specific details are set forth illustrating the Applicant's best mode for practicing the Trust Systems and Methods for Facilitating Real Estate Transfer and enabling one of ordinary skill in the art to make and use the Trust Systems and Methods for Facilitating Real Estate Transfer. It will be obvious, however, to one skilled in the art that the present Trust Systems and Methods for Facilitating Real Estate Transfer may be practiced without many of these specific details. In other instances, well-known business methods, software considerations, financial considerations, marketing techniques, regulatory schemes, and other details have not been described in particular detail in order to avoid unnecessarily obscuring this disclosure.

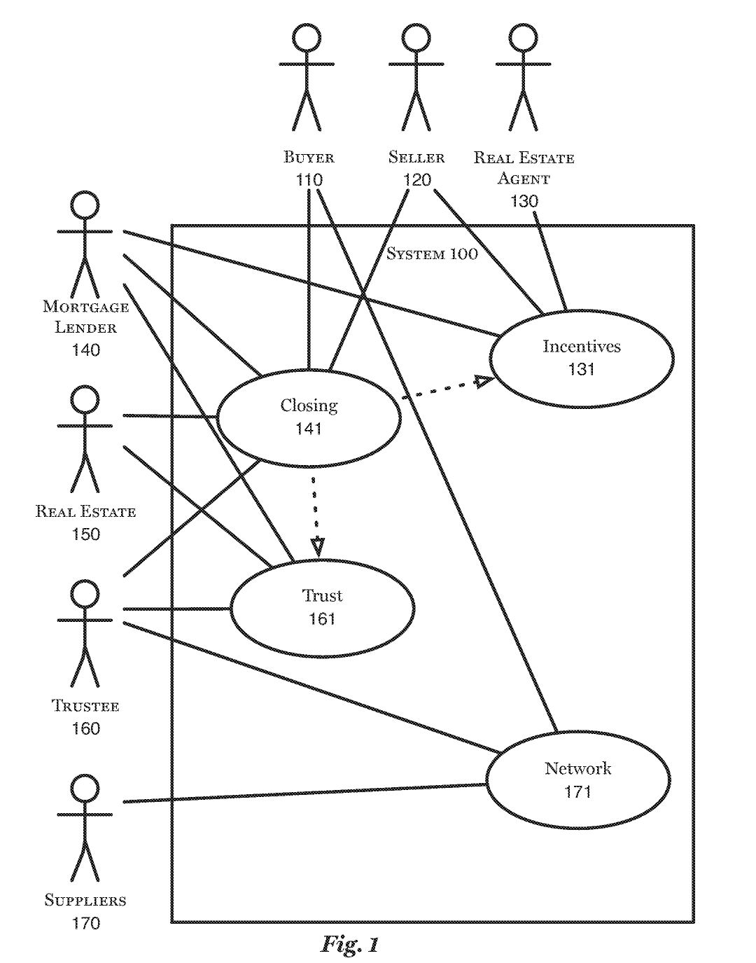

FIG. 1 shows a use-case view that illustrates a system 100 of assisting transfer of real estate 150 between a buyer 110 and a seller 120, that is organized by a real-estate agent 130, funded by a mortgage lender, and with post-closing funds for improvements overseen by a trustee 160 and supplier 170. System 100 allows seller 120, real estate agent 130 or mortgage lender 140 to create incentives 131 for the buyer 100 to purchase the real estate 150. Incentives 131 may include an allowance by the seller 120, a reduction in agency commission by the real estate agent 130 or a change in points or lending rate by the mortgage lender 140. This system allows for any of these incentives, or other situations that result in excess credit, to be readily documented on a settlement statement and subsequently used to make improvements to benefit the real estate 150.

During closing 141, the buyer 110, the seller 120, the mortgage lender 140 and the trustee participate in the transfer of the real estate 150. The mortgage lender 140 lends funds to the buyer 110 in exchange for a mortgage on the real estate 150.

During settlement, the funds are appropriately distributed to the seller 120, the real estate agent 130, and for other expenses, such as, appraisals, home warranties, and other closing costs. In this system 100, funds are also distributed to trust 161, as shown. Trust 161 holds the funds for the benefit of the real estate, that is, the funds are earmarked for improvements that benefit the real estate. The funds transferred to the trust 161 can accrue from any credit adjustment that benefits the buyer 110. The funds held in trust 161 may be spent, for example, at the discretion of buyer 110, to make improvements to the real estate, such as, appliance purchases, remodeling, painting, landscaping, repairs, etc. Said another way, the sole beneficiary of the trust 161 is the real estate 150.

Trustee 160 is appointed during creation of the trust. Trustee 160 administers the trust 161, and, the trustee 160 may not be the buyer 110. Trustee 160 may be the mortgage lender 140 or an otherwise unaffiliated third party.

To improve the real estate 150 after closing 141, buyer 110 may access the network 171. Network 171 is a group of suppliers authorized by the trustee 160. The buyer 110 can select goods or services offered by supplier 170, who is admitted to the network 171. Trustee 160 would pay supplier 170 for improvements to the real estate 150 using the funds from trust 161. Trustee 160 may also charge administrative fees for oversight of the trust 161. Trustee 160, through the establishment of the trust 161, is prohibited from making disbursements that do not benefit the real estate (other than for the trustee's own administrative expenses). In some embodiments, trustee 160 is only authorized to make distributions from the trust to the suppliers admitted to network 171 and for the trustee's 160 administrative expenses.

Supplier 170 can be admitted to the network 171 by possessing sufficient quality of goods or services and other factors determined by the trustee 160. Supplier 170 remains in the network 171 by maintaining quality by providing sufficient service to buyer 110. Supplier 170 promises to deliver quality goods and services as a condition to remain admitted to the network 171. Prior to disbursement from trust 161, trustee 160 reviews and approves improvements or proposed improvements to ascertain that the real estate benefits from the service or good provided by supplier 170.

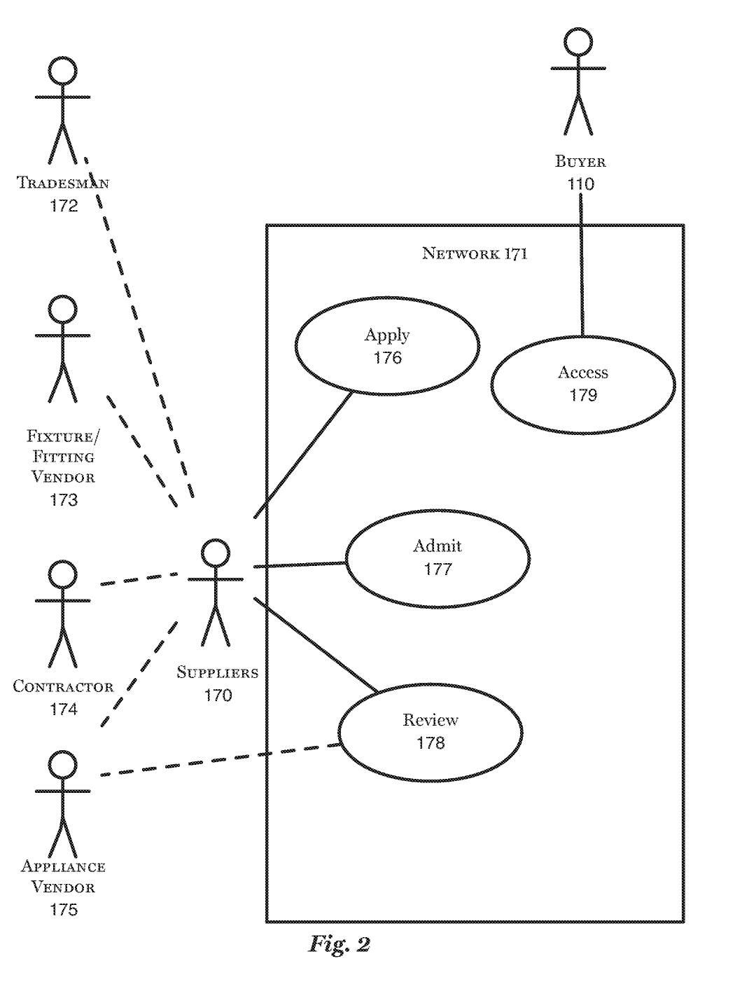

FIG. 2 shows a use case view that illustrates oversight of the network 171 of suppliers 170. To provide a wide variety of improvements to real estate, the network 171 may include a wide variety of suppliers, with multiple suppliers in each of the categories described below.

Suppliers 170 include tradesman 172 who are skilled in labor that improves real estate, such as, carpenters, electricians, plumbers, painters, landscapers, architects, laborers, handyman, roofers, and the like.

Suppliers 170 include fixture and fitting vendors 173, who may be wholesalers or retailers that provide goods used to improve real estate, for example, lumber, tile, roofing cabinetry, doors, nails, paint, pipes, wires, vents, appliances, landscape materials, concrete, beams, and all other types and kinds of fixtures and fittings that could be used to improve real estate. This includes goods useful to implement home improvement projects of all types that would be transferred with the sale of a home, including, for example, ceiling fans, light fixtures, draperies, window coverings, floor coverings, home automation, built-in entertainment systems, water-misting systems, window and door screens, windows, doors, solar systems, garage door openers, antennas, satellite dishes, mailbox, fountains, central vacuum, stoves, fireplace equipment, storage sheds, timers, watering systems, etc.

Suppliers 170 include contractor 174 who provides materials, labor or both. For example, a contractor employees tradesman 172, purchases materials from vendor 173, and provides oversight and guidance to complete an improvement project.

Suppliers 170 include appliance vendor 175 who provides home appliances. Appliance vendor 175 offers home appliances that improve the livability of the home. Appliance vendor 175 offers home appliances that are generally subject to transfer with the purchase of the home, even if, they are not permanently attached to the home, for example, washer and dryer, refrigerator, stoves, ovens, etc.

Appliance vendor 175 provides services ancillary to the appliances, for example, installation or repair services.

Supplier 170 can apply 176 for membership to the network. The trustee can establish criteria for membership, for example, minimum performance requirements, minimum satisfaction requirements, capitalization requirements, number of years in business, etc. Supplier 170 benefit by belonging to the network because funds are immediately available upon completed delivery of the goods or services. Said another way, the risk of non-payment is very low because funds are already available from a third-party trustee that is obligated to spend those funds on the real estate for improvements.

Supplier 170 may be admitted 177 to the network, usually by the trustee or the trustee's designee. Admittance to the network may include factors such as, need for the particular kind or specialization of the supplier. The trustee seeks to maintain a plurality of vendors to cover a wide variety of the services and goods buyers would desire to improve their homes. Upon admittance, supplier 170 may

be contractually required to maintain performance criteria, satisfaction ratings, or other contractual obligations related to the quality of work. The supplier may be permitted to display or advertise admission to the network 171.

Periodically, the trustee will review 178 the supplier 170 to ensure that the supplier continues to maintain performance criteria, satisfaction ratings, or other contractual obligations related to the quality of work. Review 178 can occur after interaction with buyer 110, after delivery of goods or services, monthly, quarterly or annual, or in connection with other events. Suppliers 170 that do not meet ongoing quality standard during review can be expelled from the network.

Buyer 110 is permitted access 179 to the network. Buyer 110 may select preferred suppliers from the listing of suppliers 170. Buyer 110 may contact multiple suppliers in order to obtain the best price, best quality, best timing or any other criteria of significance to the buyer.

In some embodiments of the present invention, the network may not be used, or the buyer 110 may be permitted to use parties outside of the network, yet, any payment from the trust must still to a third party (not the buyer) who has provided goods or services to improve the real estate.

In some embodiments of the present invention, the network 171 is an electronic exchange where buyer 110 can post projects and solicit bids from multiple suppliers 170. In other embodiments of the present invention, the network 171 is a catalog or listing of suppliers 170.

In some embodiments of the present invention, the trustee establishes, administers and maintains the network directly. In other embodiments, the trustee establishes, administers and maintains the network through agreement with a third party or agent.

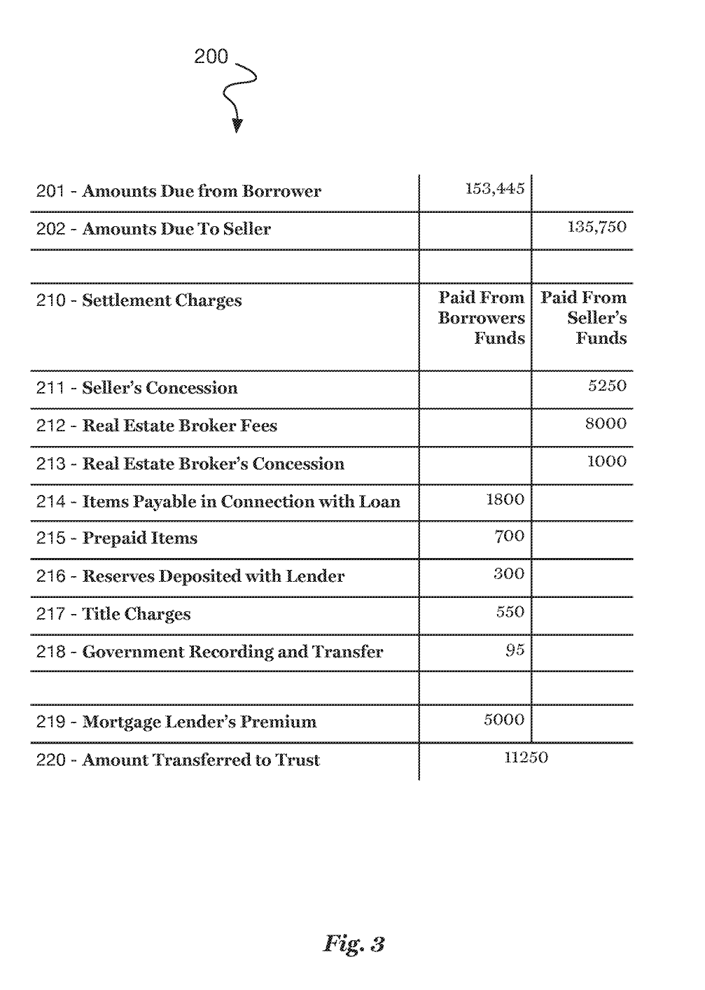

FIG. 3 shows a diagrammatic view that illustrates the settlement statement 200 of funds at closing of a real estate transaction. The settlement statement 200 is a grossly simplified statement that includes concessions and premiums that would be directed to trust 220. An actual settlement statement could be of the form of the HUD-I settlement statement, which is a form provided by the Department of Housing and Urban Development to itemize services and fees charged to the borrower by the lender or broker when applying for a loan for the purpose of purchasing or refinancing real estate.

In this example, the purchase price of the home is $150,000. The amounts due from borrower 201 is $153,445, which is greater than $150,000 because the borrower is paying for certain itemized expenses (shown lower in the settlement statement 200). The amounts due to seller is $135,750, which is less than

$150,000 because the seller is obligated to pay certain costs from the seller's proceeds (shown lower in the settlement statement 200).

The seller has made a concession 211 of $5250 to the buyer. Such a concession could be for any number of reasons, for example, an allowance to replace worn out carpeting, an allowance to remediate items found pursuant to a home inspection, an allowance to renovate a bathroom or kitchen, or any other enticement to the buyer. Generally, such concessions would be for items that do not impact the ability to occupy legally the home. Rather, such concessions are generally to impact the desirability of living in the home. Said another way, sellers can offer concessions to make the home more attractive to the buyer, without incurring the financial outlay of cash to make the improvements prior to closing, and, which may not be of interest to other potential buyers. Seller's concession 211 will be transferred to trust, that is, it is added into line 220, as shown.

One of the real estate agents has made a concession to the amount of the real estate broker's fees 212. In this example, the real estate agents were entitled to a 6% commission, which the seller agreed to pay in a broker's listing agreement. Either agent (or both together) can make a concession to receive less than the total amount of broker's fees due for their services.

The seller's real estate broker can offer an upfront incentive, for example, to attract prospective seller listings or exclusive buyer agreements. Such incentives can attract a larger pool of sellers looking for additional value for the amounts paid as a real estate broker's commission. Brokers that offer such incentives can increase the overall number of listings (thereby offsetting the concession), broaden their market base, and increase their market share.

Further the real estate agents can do this to “close the gap in negotiations” between a buyer and seller who differ by a percentage smaller than then real estate broker's commission. The buyer representative brokers can offer an incentive to inspire their client to move off-center and complete the transaction. This will create client loyalty and establish trust that will translate to increased referrals and no-cost marketing to other potential buyers.

The difference between what the real estate agents were contractually entitled to, and, what they actually accept can be listed on the settlement form as a real estate broker's concession 213, as shown. Here, the concession is $1000 and will be transferred to trust, that is, it is added into line 220, as shown.

In this example transaction, the buyer is paying the closing costs associated with transfer. For example, prepaid items 215 include items such as daily interest

charges, mortgage insurance premium, or homeowner's insurance premium. For example, reserves deposited with lender 216 include items such as escrow deposit, homeowner's insurance, mortgage insurance, property taxes and the like. For example, title charges include items such as title services, lender's title insurance, owner's title insurance, settlement fee, closing fee and the like. For example, government recording and transfer 218 include items such as government recording charges, transfer taxes, and stamping fees.

In this example, the borrower (buyer) selected a mortgage product with a credit for a higher interest rate. For example, the mortgage product includes costs of items payable in connection with loan 214, such as, origination charge, credit/charge (points) for specific interest rate chosen, appraisal fee, credit report fee, tax services, flood certification and the like. The mortgage product was selected with credit for a higher interest rate chosen by the borrower. This generates funds as a premium from the lender and is shown as mortgage lender's premium 219. Here, the premium is $5000 and will be transferred to trust, that is, it is added into line 220, as shown.

The mortgage product that generates a premium that is transferred to the trust for the benefit of the real estate provides benefit to the lender, because, those funds will eventually improve the value of the real estate that serves as collateral for the loan.

Given the seller's concession 211, the real estate broker's concession 213, and the mortgage lender's premium 219, the total amount available to transfer to trust is

$11250. Other credits to the borrower (buyer) can be the source of funds for transfer to the trust.

This may streamline the accounting on the settlement statement, because, such transactions can be readily identifiable line items. This method can be applied to conforming & non-conforming guidelines for primary residences, secondary homes and investment properties. VA and FHA loans must meet the standard loan guidelines.

In some embodiments, the credit adjustment consists entirely of a reduction of the real estate agent's commission as an incentive to the buyer to purchase the real estate. In some embodiments, the credit adjustment consists entirely of a seller's concession to the buyer. In some embodiments, the credit adjustment consists entirely of a credit related to an increase in the interest rate of the mortgage loan. In further embodiments, the credit adjustment is selected from a reduction of the real estate agent's commission as an incentive to the buyer to purchase the real estate, a seller's concession to the buyer, a credit related to an increase in the interest rate of the mortgage loan, or combinations of the foregoing.

In some embodiments of the invention, the funds deposited to trust will not be referred to as “cash” or “dollars”, but rather, as credit. This may be beneficial to reinforce with the buyer that the amount of the funds does not belong to the buyer but must be spent to improve the real estate.

In some embodiments, the trustee may charge an upfront fee, for example, 10% upon receipt of the funds from closing. In some embodiments, the trustee may be required to maintain a bond or insurance policy.

During the closing, the trust will be created. The terms of the trust may include terms such as those that follow. The duration of the trust is finite and is shorter than the term of the mortgage loan. In some embodiments, the duration of the trust may be limited to 3 months up to 24 months, inclusive.

The trust can be dissolved upon expiration of the term, or upon request of the lender or the buyer, and the balance of the trust will be transmitted to the lender to be applied to the balance on the mortgage loan. The trust cannot distribute funds to the buyer or otherwise benefit the buyer directly except to improve the real estate by funding improvements to the real estate. The trust can require that the trustee remain bonded, insured or both.

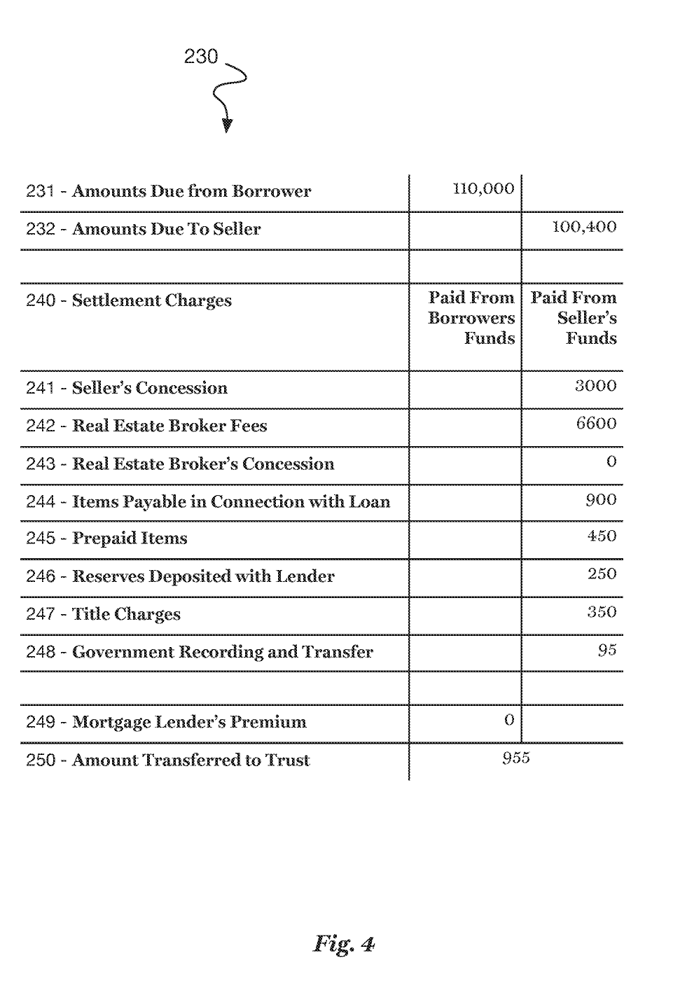

FIG. 4 shows a diagrammatic view that illustrates the settlement statement 230 of funds at closing of a real estate transaction. The settlement statement 230 is a grossly simplified statement that includes a concession by the seller 241 to help the borrower/buyer with closing costs, and, the excess concession could be directed to trust 250. In this example, the purchase price of the home is $110,000. The amounts due from borrower 231 is $110,000. The amounts due to seller is

$100,400, which is less than $110,000 because the seller is obligated to pay certain costs from the seller's proceeds, including the real estate broker's fees 242 and the buyer's closing costs (shown lower in the settlement statement 230).

In this example settlement statement, the seller has agreed to pay all of the costs associated with the transaction by providing a concession of $3,000 toward closing costs for the benefit of the buyer/borrower. Yet, the closing costs (244, 245, 246,247, & 248) amount to only $2,045, which is less that then amount promised by the seller. The remainder of the seller's concession 241 is $955. This amount is available to be transferred to trust 250, as shown. This example demonstrates how this system solves traditional problems with documenting settlements, which do not have a preferred method for dealing with excess fund from concessions or premiums.

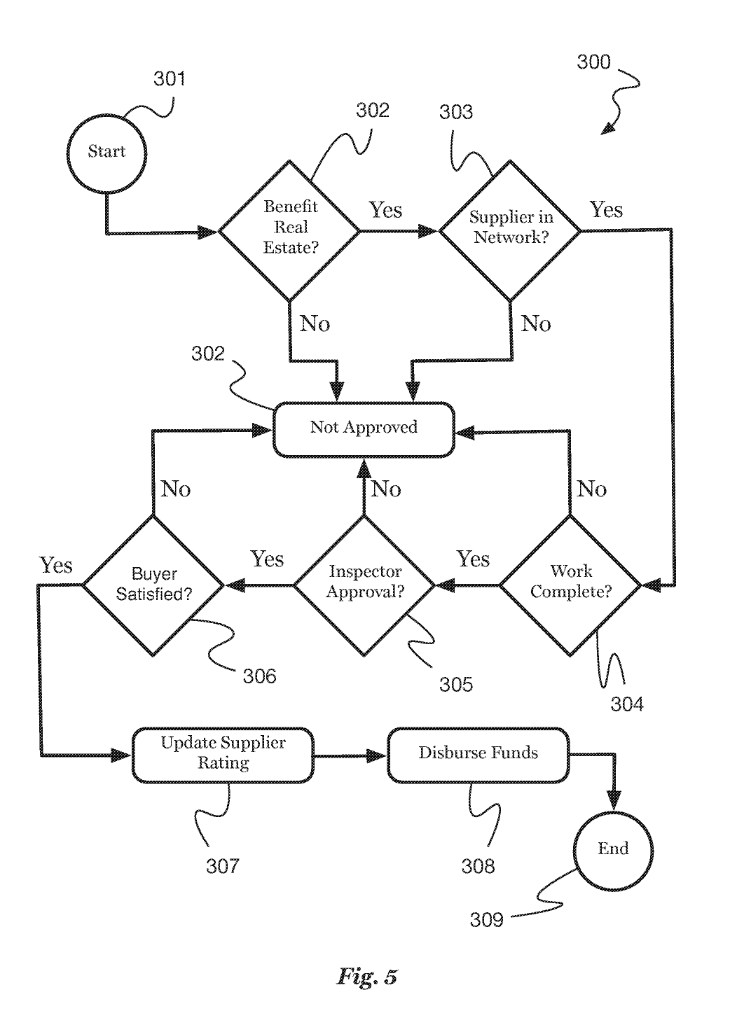

FIG. 5 shows a flowchart view that illustrates the process 300 for disbursement to suppliers from the trust for improvements to the real estate. Prior to requesting disbursement, the buyer solicits bids, proposals or prices from any of the suppliers in the network (See FIG. 2). The buyer works directly with the supplier. The buyer can solicit bids or proposals from multiple suppliers and select the supplier that they prefer. The buyer notifies the trustee and provides information related to the accepted bid, proposal or price. The trustee can monitor the relationship and provide funds for each stage of the bid or proposal. Sometimes bids or proposals come in multiple stages. For example, first, an initial stage, for example for purchase of materials, fixtures or fittings needed to complete the project. Next, one or more stages for partial progress and additional materials. Then finally, a final stage where work is fully completed.

Alternately, for certain purchases of goods, the buyer can contact a vendor (fixture, fitting or appliance) in the network and negotiate a price. The trustee can issue payment directly, or through gift card for the vendor, or through electronic means.

The process 300 can be used to evaluate whether a disbursement from trust can be made pursuant to the limitation of the trust. From the start 301, the trustee must first establish that the disbursement benefits the real estate at step 302.

Generally, the proposed improvement must attach permanently to the real estate or be property of such a character that it normally transfers with the sale of the real estate, for example, home appliances. If it does not benefit the real estate, the trustee can notify the buyer and supplier that the disbursement is not approved.

Next, at step 303, the trustee must establish that the proposed supplier belongs to the network and is in good standing. Again, if the supplier is not admitted to the network, the trustee will notify the buyer.

Next, at step 304, the trustee must determine if the work is complete. This step can evaluate differently for different suppliers, goods and services. For example, for vendors of goods, this step may merely verify that the proposed good is of a type available to the vendor. For bids or proposals that do not have multiple stages, it may be verification that all work is complete, including inspections from local authorities. For bids or proposals that do have multiple stages, it may be obtaining assurances from the supplier that the requirements of the stage are complete.

Next, at step 305, the trustee can require an inspection of the completed work. Again, for goods, this step may be optional or unnecessary. For proposals involving services, the inspection would likely occur only at the end. The trustee can determine the type and number of inspections required.

Next, at step 306, the trustee would confirm with the buyer that the work was completed satisfactorily. The trustee can collect whatever information that would be desirable to determine if the supplier is meeting its contractual obligations to the network.

Upon successful completion of all the necessary steps, the trustee can update the supplier's rating with information for this particular disbursement at step 307. This information can be used to determine whether the supplier continues in good standing. Finally, the trustee will disburse funds directly to the suppler at step

308. The trustee must ascertain that any disbursement does not result in cash back to the buyer. This ends 309 the process 300.

An alternative for disbursement is to provide credentials to the buyer so the buyer can initiate an electronic payment from the trust to the supplier in order to purchase the supplier's good or services for the benefit of the real estate. For example, the trustee can provide a gift certificate (gift card) to the buyer, where the gift certificate is only redeemable with one or more of the suppliers admitted to the network. This would allow the buyer to make purchases from the supplier to benefit the real estate. In other embodiments, other kinds of credentials and other kinds of electronic payments could be preferred.

The methods and system as described herein are preferably performed by a processor on a computer such as a server. In preferred embodiments, the computer is accessible by a network such as the internet and may be running in the cloud. In other preferred embodiments, the methods and system as described herein are preferably performed by a processor on a computer without the need for a network.

### EXAMPLES

The following are examples of how the described embodiments may be used:
In embodiment number one, a method, for assisting transactions of real estate to be purchased by buyers who finance the transactions using mortgage loans, may comprising the steps of:
maintaining a network of suppliers who improve real estate by supplying goods or services;
admitting suppliers to the network by assessing the reputation of the suppliers and the quality of the suppliers' goods or services;
during closing of the transactions, permitting the buyers to take out mortgage loans to pay at least partially for the transactions;
creating a plurality of trusts, at least one for each of the transactions, by holding funds for the benefit of the real estate transferred during the closing,
wherein the funds accrue from credit adjustments that benefit the buyer of the real estate transferred during the closing,
wherein the trustee of the trust is not the buyer of the real estate transferred during the closing;
permitting the buyers access to the network to select one or more suppliers to make improvements that benefit the real estate transferred during the closing;
after closing of the transactions, disbursing funds from the trust to pay for the improvements, so long as, the improvements benefit the real estate transferred during the closing; and
prohibiting the trustee from making disbursements outside of the network of suppliers, except to reimburse the trustee's fees for administration, whenever funds are held in trust for the benefit of the real estate transferred during the closing.
In embodiment number two embodiment number one may further comprise the step of:
during closing of the transactions, reporting the transmittal of funds to the trust on a settlement statement.
In embodiment number three the embodiment of one or more of the prior embodiments include:
the duration of each trust is less than the term of the mortgage loan on the real estate transferred during the closing.
In embodiment number 4 the embodiment of one or more of the prior embodiments further comprising the step of:
upon dissolution of each trust, permitting the trustee to disburse any amount remaining in the trust to lower the balance on the mortgage loan on the real estate transferred during the closing.
In embodiment number 5 the embodiment of one or more of the prior embodiments may further requiring the step of:
requiring the trustee to maintain a bond or an insurance policy in at least the amount of the balance of the trusts.
In embodiment number six the embodiment of one or more of the prior embodiments may further comprises the step of:
prior to the step of disbursing funds, verifying with the buyers that the improvement is satisfactory.
In embodiment number seven the embodiment of one or more of the prior embodiments wherein the step of disbursing funds further comprises the step of:
transmitting payment directly to the supplier.

In embodiment number eight the embodiment of one or more of the prior embodiments wherein the step of disbursing funds further comprises the step of:
providing a gift certificate to the buyer, wherein the gift certificate is only redeemable with one or more of the suppliers admitted to the network, whereby, the buyer can make purchases from the supplier to benefit the real estate.
In embodiment number nine the embodiment of one or more of the prior embodiments wherein the step of disbursing funds further comprises the step of:
providing credentials to the buyer so the buyer can initiate an electronic payment from the trust to the supplier in order to purchase the supplier's good or services for the benefit of the real estate.
In embodiment number ten the embodiment of one or more of the prior embodiments further comprising the step of:
requiring suppliers to maintain a certain performance quality to remain admitted to the network.
In embodiment number eleven the embodiment of one or more of the prior embodiments wherein:
the credit adjustment consists entirely of a reduction of the real estate agent's commission as an incentive to the buyer to purchase the real estate.
In embodiment number twelve the embodiment of one or more of the prior embodiments wherein:
the credit adjustment consists entirely of a seller's concession to the buyer.
In embodiment number thirteen the embodiment of one or more of the prior embodiments wherein:
the credit adjustment consists entirely of a credit related to an increase in the interest rate of the mortgage loan.
In embodiment number fourteen the embodiment of one or more of the prior embodiments wherein:
the credit adjustment is selected from the group consisting of
   a) a reduction of the real estate agent's commission as an incentive to the buyer to purchase the real estate,
   b) a seller's concession to the buyer,
loan, or a credit related to an increase in the interest rate of the mortgage
   c) combinations of the foregoing.
In embodiment number fifteen the embodiment of one or more of the prior embodiments wherein:
the suppliers include a tradesman skilled in labor to improve real estate.
In embodiment number sixteen the embodiment of one or more of the prior embodiments wherein:
the suppliers include a vendor of fixtures or fittings for real estate improvement.
In embodiment number seventeen the embodiment of one or more of the prior embodiments wherein:
the suppliers include a vendor of home appliances or goods for home improvement.
In embodiment number eighteen the embodiment of one or more of the prior embodiments wherein:
the suppliers include a contractor who contractually provides materials or labor for real estate improvement, home improvement, or home appliances.
In embodiment number nineteen the embodiment of one or more of the prior embodiments wherein:
the suppliers include a tradesman skilled in labor to improve real estate, a vendor of fixtures or fittings for real estate improvement,
a vendor of home appliances or goods for home improvement, and
a contractor who contractually provides materials or labor for real estate improvement, home improvement, or home appliances.
In embodiment number twenty the embodiment of one or more of the prior embodiments wherein:
the credit adjustment is selected from the group consisting of
   a reduction of the real estate agent's commission as an incentive to the buyer to purchase the real estate,
   a seller's concession to the buyer,
   a credit related to an increase in the interest rate of the mortgage loan, and
   combinations of the foregoing.
In embodiment number twenty-one the embodiment of one or more of the prior embodiments further comprising the step of:
during closing of the transactions, reporting the disbursement of funds to the trust on a settlement statement.
In embodiment number twenty-two the embodiment of one or more of the prior embodiments further comprising the step of:
upon dissolution of each trust, permitting the trustee to disburse any amount remaining in the trust to lower the balance on the mortgage loan on the real estate transferred during the closing,
wherein the duration of each trust is less than the term of the mortgage loan on the real estate transferred during the closing;
prior to the step of disbursing funds, verifying with the buyers that the improvement was satisfactorily completed by the supplier.
In embodiment number twenty-three the embodiment of one or more of the prior embodiments wherein the step of disbursing funds further comprises the steps of:
transmitting payment directly to the supplier;
providing a gift certificate to the buyer, wherein the gift certificate is only redeemable with one or more of the suppliers admitted to the network, whereby, the buyer can make purchases from the supplier to benefit the real estate; and
providing credentials to the buyer so the buyer can initiate an electronic payment from the trustee to the supplier in order to purchase the supplier's good or services for the benefit of the real estate.
In embodiment number twenty-four the embodiment of one or more of the prior embodiments further comprises the steps of:
requiring the trustee to maintain a bond or an insurance policy in at least the amount of the balance of the trusts; and
requiring suppliers to maintain a certain performance quality to remain admitted to the network.
In embodiment number twenty-five the embodiment of one or more of the prior embodiments further comprises the step of: verifying with the buyers that the improvement is satisfactory.
In embodiment number twenty-six, a method for assisting a transaction of real estate organized by at least one real estate agent, and to be purchased by a buyer who finances the transaction using a mortgage loan from a mortgage lender, may comprise the steps of:
prior to an agreement to purchase the real estate, enabling the real estate agent to offer a reduction of the real estate agent's commission as an incentive to the buyer to enter into the agreement;
establishing a trust, wherein the beneficiary of the trust consists solely of the real estate, wherein the trustee of the trust is not the buyer;
during closing, permitting the mortgage lender to provide a mortgage to the buyer to pay at least partially for the transaction;
during closing, transmitting funds to the trust in at least the amount of the reduction of the real estate agent's commission,
wherein the beneficiary of the trust consists solely of the real estate, wherein the trustee of the trust is not the buyer;
during closing, reporting the transmittal of funds to the trust on a settlement statement;
after closing, disbursing funds from the trust to pay for the improvements, so long as, the improvements benefit the real estate; and
after closing, preventing disbursements from the trust that do not benefit the real estate, except to pay for the trustee's fees for services rendered to the trust.
In embodiment number twenty-seven, the embodiment of one or more of the prior embodiments wherein:
the duration of the trust is less than the term of the mortgage loan on the real estate transferred during the closing.
In embodiment number twenty-eight, the embodiment of one or more of the prior embodiments further comprising the step of:
upon dissolution of the trust, permitting the trustee to disburse any amount remaining in the trust to lower the balance on the mortgage loan on the real estate transferred during the closing.
In embodiment number twenty-nine, the embodiment of one or more of the prior embodiments wherein:
disbursements from the trust may not be paid to benefit the buyer directly.
In embodiment number thirty, the embodiment of one or more of the prior embodiments wherein:
requiring the trustee to maintain a bond or an insurance policy for the balance of the trust.
In embodiment number thirty-one, the embodiment of one or more of the prior embodiments further comprises the step of:
prior to the step of disbursing, verifying with the buyer that the improvement to the real estate was satisfactory.
In embodiment number thirty-two, the embodiment of one or more of the prior embodiments wherein the step of disbursing further comprises the step of:
transmitting payment directly to the supplier.
In embodiment number thirty-three the embodiment of one or more of the prior embodiments wherein the step of disbursing further comprises the step of:
maintaining a network of suppliers who improve real estate by supplying goods or services;
admitting suppliers to the network by assessing the reputation of the suppliers and the quality of the suppliers' goods or services; and
during the duration of the trust, prohibiting the trustee from making disbursements outside of the network of suppliers, except to reimburse the trustee's fees for administration of the trusts.
In embodiment number thirty-four, the embodiment of one or more of the prior embodiments wherein the step of disbursing funds further comprises the step of:
providing a gift certificate to the buyer, wherein the gift certificate is only redeemable with one or more of the suppliers admitted to the network, whereby, the buyer can make purchases from the supplier to benefit the real estate.
In embodiment number thirty-five, the embodiment of one or more of the prior embodiments wherein the step of disbursing funds further comprises the step of:
providing credentials to the buyer so the buyer can initiate an electronic payment from the trustee to the supplier in order to purchase the supplier's good or services for the benefit of the real estate.
In embodiment number thirty-six, the embodiment of one or more of the prior embodiments wherein:
the supplier includes a tradesman skilled in labor to improve real estate, a vendor of fixtures or fittings for real estate improvement,
a vendor of home appliances or goods for home improvement, and
a contractor who contractually provides materials or labor for real estate improvement, home improvement, or home appliances.
In embodiment number thirty-seven, the embodiment of one or more of the prior embodiments further comprising the step of:
upon dissolution of the trust, permitting the trustee to disburse any amount remaining in the trust to lower the balance on the mortgage loan on the real estate transferred during the closing,
wherein the duration of the trust is less than the term of the mortgage loan on the real estate transferred during the closing;
prior to the step of disbursing funds, verifying with the buyers that the improvement was satisfactorily completed by the supplier.
In embodiment number thirty-eight, the embodiment of one or more of the prior embodiments wherein the step of disbursing funds further comprises the steps of:
transmitting payment directly to the supplier;
providing a gift certificate to the buyer, wherein the gift certificate is only redeemable with one or more of the suppliers admitted to the network, whereby, the buyer can make purchases from the supplier to benefit the real estate; and
providing credentials to the buyer so the buyer can initiate an electronic payment from the trustee to the supplier in order to purchase the supplier's good or services for the benefit of the real estate.
In embodiment number thirty-nine, the embodiment of one or more of the prior embodiments further comprises the steps of:
requiring the trustee to maintain a bond or an insurance policy in at least the amount of the balance of the trusts; and
requiring suppliers to maintain a certain performance quality to remain admitted to the network.
In embodiment number forty, the embodiment of one or more of the prior embodiments further comprises the step of: verifying with the buyers that the improvement is satisfactory.
In embodiment number forty-one, a method for assisting a transaction of real estate to be purchased by a buyer who finances the transaction using a mortgage loan from a mortgage lender, may comprise the steps of:
prior to an agreement to purchase the real estate, enabling the mortgage lender to offer funds for real estate improvement in connection with a mortgage loan as an incentive to the buyer to enter into the agreement;
establishing a trust, wherein the beneficiary of the trust consists solely of the real estate,
wherein the trustee of the trust is not the buyer;
during closing, allowing the mortgage lender to provide a mortgage to the buyer to pay at least partially for the transaction;
during closing, transmitting funds to the trust in at least the amount of the funds for real estate improvement,
wherein the beneficiary of the trust consists solely of the real estate, wherein the trustee of the trust is not the buyer;
during closing, reporting the transmittal of funds to the trust on a settlement statement;
after closing, disbursing funds from the trust to pay for the improvements, so long as, the improvements benefit the real estate; and
after closing, preventing disbursements from the trust that do not benefit the real estate, except to pay for the trustee's fees for services rendered to trust.
In embodiment number forty-two, the embodiment of one or more of the prior embodiments wherein:
the duration of the trust is less than the term of the mortgage loan on the real estate transferred during the closing.
In embodiment number forty-three, the embodiment of one or more of the prior embodiments further comprising the step of:
upon dissolution of the trust, permitting the trustee to disburse any amount remaining in the trust to lower the balance on the mortgage loan on the real estate transferred during the closing.
In embodiment number forty-four, the embodiment of one or more of the prior embodiments wherein:
disbursements from the trust may not be paid to benefit the buyer directly.
In embodiment number forty-five, the embodiment of one or more of the prior embodiments further comprising the step of:
requiring the trustee to maintain a bond or an insurance policy for the balance of the trust.
In embodiment number forty-six, the embodiment of one or more of the prior embodiments further comprising the step of:
prior to the step of disbursing, verifying with the buyer that the improvement to the real estate was satisfactory.
In embodiment number forty-seven, the embodiment of one or more of the prior embodiments wherein the step of disbursing further comprises the step of:
transmitting payment directly to the supplier.
In embodiment number forty-eight, the embodiment of one or more of the prior embodiments wherein the step of disbursing further comprises the step of:
maintaining a network of suppliers who improve real estate by supplying goods or services;
admitting suppliers to the network by assessing the reputation of the suppliers and the quality of the suppliers' goods or services; and
during the duration of the trust, prohibiting the trustee from making disbursements outside of the network of suppliers, except to reimburse the trustee's fees for administration of the trusts.

In embodiment number forty-nine, the embodiment of one or more of the prior embodiments wherein the step of disbursing funds further comprises the step of:
providing a gift certificate to the buyer, wherein the gift certificate is only redeemable with one or more of the suppliers admitted to the network, whereby, the buyer can make purchases from the supplier to benefit the real estate.
In embodiment number fifty, the embodiment of one or more of the prior embodiments wherein the step of disbursing funds further comprises the step of:
providing credentials to the buyer so the buyer can initiate an electronic payment from the trustee to the supplier in order to purchase the supplier's good or services for the benefit of the real estate.
In embodiment number fifty-one, the embodiment of one or more of the prior embodiments wherein:
the supplier includes a tradesman skilled in labor to improve real estate, a vendor of fixtures or fittings for real estate improvement,
a vendor of home appliances or goods for home improvement,
a contractor who contractually provides materials or labor for real estate improvement, home improvement, or home appliances.
In embodiment number fifty-two, the embodiment of one or more of the prior embodiments further comprising the step of:
upon dissolution of the trust, permitting the trustee to disburse any amount remaining in the trust to lower the balance on the mortgage loan on the real estate transferred during the closing,
wherein the duration of the trust is less than the term of the mortgage loan on the real estate transferred during the closing;
prior to the step of disbursing funds, verifying with the buyers that the improvement was satisfactorily completed by the supplier.
In embodiment number fifty-three, the embodiment of one or more of the prior embodiments wherein the step of disbursing funds further comprises the steps of:
transmitting payment directly to the supplier;
providing a gift certificate to the buyer, wherein the gift certificate is only redeemable with one or more of the suppliers admitted to the network, whereby, the buyer can make purchases from the supplier to benefit the real estate; and
providing credentials to the buyer so the buyer can initiate an electronic payment from the trustee to the supplier in order to purchase the supplier's good or services for the benefit of the real estate.
In embodiment number fifty-four, the embodiment of one or more of the prior embodiments further comprises the steps of:
requiring the trustee to maintain a bond or an insurance policy in at least the amount of the balance of the trusts; and
requiring suppliers to maintain a certain performance quality to remain admitted to the network.
In embodiment number fifty-five, the embodiment of one or more of the prior embodiments further comprises the step of:
verifying with the buyers that the improvement was satisfactory.

Although Applicant has described Applicant's preferred embodiments of this invention, it will be understood that the broadest scope of this invention includes modifications and implementations apparent to those skilled in the art after reading the above specification and the below claims. Such scope is limited only by the below claims as read in connection with the above specification. Further, many other advantages of Applicant's invention will be apparent to those skilled in the art from the above descriptions and the below claims.

What is claimed is:

1. A method, for assisting transactions of real estate to be purchased by buyers who finance the transactions using mortgage loans, comprising the steps of:
maintaining a network of suppliers who improve real estate by supplying goods or services;
admitting suppliers to the network by assessing the reputation of the suppliers and the quality of the suppliers' goods or services;
during closing of the transactions, permitting the buyers to take out mortgage loans to pay at least partially for the transactions;
creating a plurality of trusts, at least one for each of the transactions, by holding funds for the benefit of the real estate transferred during the closing,
wherein the funds accrue from credit adjustments that benefit the buyer of the real estate transferred during the closing,
wherein the trustee of the trust is not the buyer of the real estate transferred during the closing;
permitting the buyers access to the network to select one or more suppliers to make improvements that benefit the real estate transferred during the closing;
after closing of the transactions, disbursing funds from the trust to pay for the improvements, so long as, the improvements benefit the real estate transferred during the closing; and
prohibiting the trustee from making disbursements outside of the network of suppliers, except to reimburse the trustee's fees for administration, whenever funds are held in trust for the benefit of the real estate transferred during the closing.

2. The method of claim 1 further comprising the step of:
during closing of the transactions, reporting the transmittal of funds to the trust on a settlement statement.

3. The method of claim 1 wherein:
the duration of each trust is less than the term of the mortgage loan on the real estate transferred during the closing.

4. The method of claim 3 further comprising the step of:
upon dissolution of each trust, permitting the trustee to disburse any amount remaining in the trust to lower the balance on the mortgage loan on the real estate transferred during the closing.

5. The method of claim 1 further requiring the step of:
requiring the trustee to maintain a bond or an insurance policy in at least the amount of the balance of the trusts.

6. The method of claim 1 further comprises the step of:
prior to the step of disbursing funds, verifying with the buyers that the improvement is satisfactory.

7. The method of claim 6 wherein the step of disbursing funds further comprises the step of:
transmitting payment directly to the supplier.

8. The method of claim 1 wherein the step of disbursing funds further comprises the step of:
providing a gift certificate to the buyer, wherein the gift certificate is only redeemable with one or more of the suppliers admitted to the network, whereby, the buyer can make purchases from the supplier to benefit the real estate.

9. The method of claim 1 wherein the step of disbursing funds further comprises the step of:
providing credentials to the buyer so the buyer can initiate an electronic payment from the trust to the supplier in order to purchase the supplier's good or services for the benefit of the real estate.

10. The method of claim 1 further comprising the step of:
requiring suppliers to maintain a certain performance quality to remain admitted to the network.

11. The method of claim 1 wherein:
the credit adjustment consists entirely of a reduction of the real estate agent's commission as an incentive to the buyer to purchase the real estate.

12. The method of claim 1 wherein:
the credit adjustment consists entirely of a seller's concession to the buyer.

13. The method of claim 1 wherein:
the credit adjustment consists entirely of a credit related to an increase in the interest rate of the mortgage loan.

14. The method of claim 1 wherein:
the credit adjustment is selected from the group consisting of
a) a reduction of the real estate agent's commission as an incentive to the buyer to purchase the real estate,
b) a seller's concession to the buyer,
loan, or a credit related to an increase in the interest rate of the mortgage
c) combinations of the foregoing.

15. The method of claim 1 wherein:
the suppliers include a tradesman skilled in labor to improve real estate.

16. The method of claim 1 wherein:
the suppliers include a vendor of fixtures or fittings for real estate improvement.

17. The method of claim 1 wherein:
the suppliers include a vendor of home appliances or goods for home improvement.

18. The method of claim 1 wherein:
the suppliers include a contractor who contractually provides materials or labor for real estate improvement, home improvement, or home appliances.

19. The method of claim 1 wherein:
the suppliers include a tradesman skilled in labor to improve real estate, a vendor of fixtures or fittings for real estate improvement,
a vendor of home appliances or goods for home improvement, and
a contractor who contractually provides materials or labor for real estate improvement, home improvement, or home appliances.

20. The method of claim 19 wherein:
the credit adjustment is selected from the group consisting of
a reduction of the real estate agent's commission as an incentive to the buyer to purchase the real estate,
a seller's concession to the buyer,
a credit related to an increase in the interest rate of the mortgage loan, and
combinations of the foregoing.
